(19) United States
(12) Patent Application Publication
(10) Pub. No.: US 2014/0199057 A1
(43) Pub. Date: Jul. 17, 2014

(54) Warming System for Dialysis Fluid

(71) Applicant: ENTHERMICS MEDICAL SYSTEMS, INC., Menomonee Falls, WI (US)

(72) Inventors: William J. Hansen, Pewaukee, WI (US); Terence T. Smith, Waukesha, WI (US)

(73) Assignee: ENTHERMICS MEDICAL SYSTEMS, INC., Menomonee Falls, WI (US)

(21) Appl. No.: 13/740,599

(22) Filed: Jan. 14, 2013

(51) Int. Cl. H05B 3/02

(52) U.S. Cl. CPC H05B 3/02
USPC 392/443

(57) ABSTRACT

A warming system for large volume dialysis bags provides a basin configured to position the bags in a low thickness, wrinkle free configuration for maximum heat transfer. A centrally positioned thermal sensing element may provide accurate temperature measurement of interior bag temperature by a correction process and a weight sensor may automatically control the heater when the bag is in place.

### BACKGROUND OF THE INVENTION

The present invention relates to warming systems for medical fluids and in particular to a warming system adapted to large fluid volumes used in peritoneal dialysis.

Peritoneal dialysis is often used in the treatment of patients with severe kidney disease as an alternative to hemodialysis. While hemodialysis removes waste and excess water from the blood using an external semipermeable membrane as a substitute for the kidney, peritoneal dialysis uses for this purpose the patient's peritoneum membrane that lines the abdominal cavity. Generally, a large quantity of sterile fluid is introduced into the abdomen (approximately 5 liters) where it resides to collect waste products from the proximate blood vessels. The water is then withdrawn bringing with it waste products. This process is repeated on a regular basis.

Infusing the large amount of dialysate needed for this procedure can uncomfortably change the core temperature of the patient, particularly when the dialysate is at room temperature, substantially below normal body core temperatures. Properly warming the dialysate is complicated by the fact that it is normally maintained within a sterile plastic bag having relatively low thermal conductivity and low resistance to elevated temperatures and by the large volume of liquid which requires significant heat input to effect the necessary temperature change and which can be subject to thermal stratification.

### SUMMARY OF THE INVENTION

The present invention provides a warming device for dialysate or similar fluids having a basin shape to flatten the dialysate bag and maximize an interface surface between the bag and the heated walls of the basin. By reducing the length of the thermal path through the dialysate and providing a large heating area contacting a broad surface of the bag, effective, fast and uniform warming of the dialysate can be obtained with gentle heat.

Specifically the invention provides, in one embodiment, a warming system for infusible liquids having an upwardly open basin sized to receive a flexible polymer bag holding the infusible liquid. The basin provides a substantially horizontal floor having upwardly sloped opposed ends and sides adapted to support the flexible polymer bag in contact with the floor, end, and sides so as to reduce a vertical thickness of the bag while maintaining a substantially wrinkle free contact between the bag and the basin. A heater element is attached to the basin to conduct heat through the basin and bag into the contained infusible liquid when the bag is held within the basin.

It is thus one feature of at least one embodiment of the invention to provide a warming system that can rapidly warm large volumes of dialysate to a uniform temperature by providing a heating surface that promotes a high surface to volume configuration of the dialysis bag.

The heater element may contact each of the floor, ends, and sides to heat each of these surfaces and to conduct heat through each of these surfaces into the infusible liquid.

It is thus a feature of at least one embodiment of the invention to make use of the ends and sides of the basin both for shaping of the bag and heating of the liquid.

The area of the floor, ends, and sides together may be an area of greater than 100 square inches.

It is thus a feature of at least one embodiment of the invention to allow rapid heating of a dialysate with relatively low temperature heaters by increasing the heat transmission interface.

The basin may include a conductive metal heat spreader and the heater is attached to an outer surface of the basin.

It is thus a feature of at least one embodiment of the invention to eliminate hot spots at the heater interface that would promote temperature variations within the dialysate and reduce the efficiency of the heat transfer.

The basin may be mounted within a housing open at a top to expose an upper surface of the basin.

It is thus a feature of at least one embodiment of the invention to provide a unit that may be conveniently placed on a tabletop for home healthcare use or other setting including a clinic or hospital.

The invention may provide a dialysate sensor controlling the heater to be on only when a predetermined amount of dialysate is in the basin.

It is thus a feature of at least one embodiment of the invention to provide for automatic liquid heating without the need to manipulate controls.

The basin may be attached to the housing by spring elements allowing the basin to move under the weight of a contained bag and may further include an electrical switch sensing this movement to control the heater.

It is thus a feature of at least one embodiment of the invention to provide for a highly reliable sensor for the presence of the dialysis bag within the warming unit to provide for one or both of automatic heating of an inserted bag and automatic shutoff of the unit when the bag is removed without additional action by the user.

The system may further include a thermal sensor protruding upward from a floor of the basin to contact a bag placed within the basin.

It is thus a feature of at least one embodiment of the invention to provide for a temperature sensor for automatic control of the heating element that may be closely coupled to the interior dialysate temperature. Upward projection of the temperature sensor ensures good contact between the bag and the sensor.

The thermal sensor may be substantially centered within the basin.

It is thus a feature of at least one embodiment of the invention to provide a sensor that closely couples to average dialysate temperature as represented by a center volume of the dialysate.

The thermal sensor may include a thermal isolation element separating the thermal sensor from the basin.

It is thus an object of at least one embodiment of the invention to permit juxtaposition of the heating element and sensor in close proximity without interference.

The thermal isolation element may be a thermally insulating ring supporting the thermal sensor in a hole through the basin.

It is thus a feature of at least one embodiment of the invention to provide a simple mechanism for integrating a thermal sensor for the dialysate into the basin.

The temperature sensor may include a pair of temperature sensing elements that may be independently read and combined to deduce temperature.

It is thus a feature of at least one embodiment of the invention to provide for greater precision in temperature measurement by obtaining different temperature samples of the dialysate and further to provide an ability to detect temperature sensor failure when the different temperature measurements deviate beyond a predetermined threshold.

The warming system may further include user controls for providing a temperature display of a temperature of the infusible liquid and a correction circuit communicating with the display and the temperature sensor to add a temperature offset to a reading of the temperature sensor for display on the display, the temperature offset based on an empirically determined thermal resistance between the heater element and the infusible liquid.

It is thus a feature of at least one embodiment of the invention to provide an accurate indication of the dialysate temperature using an external temperature probe preserving the sterility of the dialysis bag system. By modeling the thermal circuit of the dialysis bag and thermal sensor interface, accurate dialysate temperatures may be deduced from outside the bag.

The control system may communicate between the heater and the thermal sensor for controlling the heater according to a reading of the thermal sensor and a desired temperature set point.

It is thus a feature of at least one embodiment of the invention to permit user adjustment within a narrow range of the dialysate temperature using feedback control.

The control system may control the heater to match a temperature from the temperature sensor plus the temperature offset determined by the correction circuit to the desired temperature setpoint.

It is thus a feature of at least one embodiment of the invention to employ the same thermal modeling for accurate control of the dialysate temperature.

The basin may include cut out portions exposing an under surface of the bag when the bag is supported in the basin, the cut out portions positioned to receive a user's hands for grasping the bag for placement or removal of the bag into or from the basin.

It is thus a feature of at least one embodiment of the invention to provide a highly ergonomic warming system allowing an individual to easily manage large dialysis bags.

The edges of the basin may provide for a downwardly extending rim providing a drip edge preventing water overflowing from the basin from traveling along and under surface of the basin.

It is thus a feature of at least one embodiment of the invention to anticipate and manage possibly large dialysate spills and to divert any such spills from the heater system.

The heater may be a flexible silicone heater pad adhered to an under surface of a metallic basin.

It is thus a feature of at least one embodiment of the invention to provide a heater that may closely conform to a curved basin surface used in the present invention.

These particular features and advantages may apply to only some embodiments falling within the claims and thus do not define the scope of the invention.

### BRIEF DESCRIPTION OF THE FIGURES

FIG. 1 is a front perspective view of the warming system of the present invention showing an upwardly open basin for receiving a bag of sterile dialysate as may be grasped at the ends by a user and placed in the basin with a user's hands insertable into cutouts in the basin for ease of handling the bag;

FIG. 2 is a fragmentary cross-section along line 2-2 of FIG. 1 showing attachment of the heater pad to an outer surface of the basin, a spring mounting of the basin within a housing for sensing of placement of the bag, and a centrally mounted, thermally-isolated external temperature sensor for deducing liquid temperature within the bag;

FIG. 3 is a top plan view of the basin of FIG. 1 showing positioning of a silicone heating pad to provide a gentle heat through a basin floor, end walls and sidewalls;

FIG. 4 is a fragmentary cross-section similar to FIG. 2 taken along line 4-4 of FIG. 3 showing cutouts in the basin exposing an under surface of the bag for simplified bag placement and removal;

FIG. 5 is a flowchart of a program that may be executed by a controller board of the warming system; and

FIG. 6 is a front elevational view of a control panel provided by the present invention.

### DETAILED DESCRIPTION OF THE PREFERRED EMBODIMENT

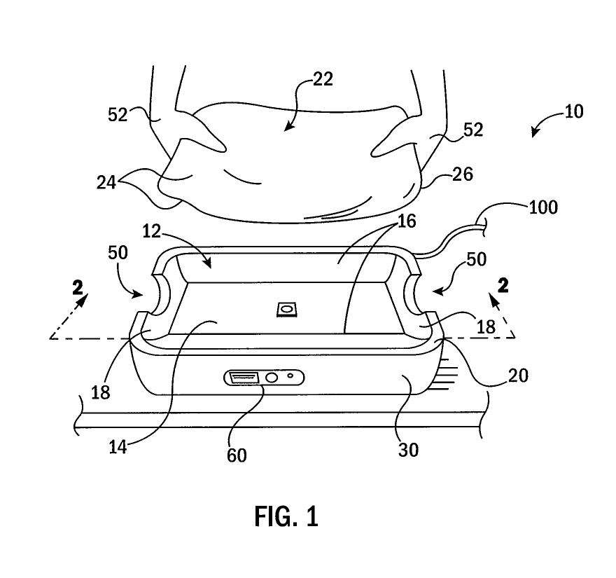

Referring now to FIG. 1, a warming system 10 of the present invention may provide for an upwardly open, concave basin 12 having a generally horizontal floor 14 surrounded by upwardly sloping and opposed sidewalls 16 and upwardly sloping and opposed end walls 18. The end walls 18 join with the sidewalls 16 to provide a continuous watertight surface terminating at an upper rim 20. Generally the basin 12 will be fabricated from a ductile conductive metal such as aluminum to provide a heat spreading feature as will be described below.

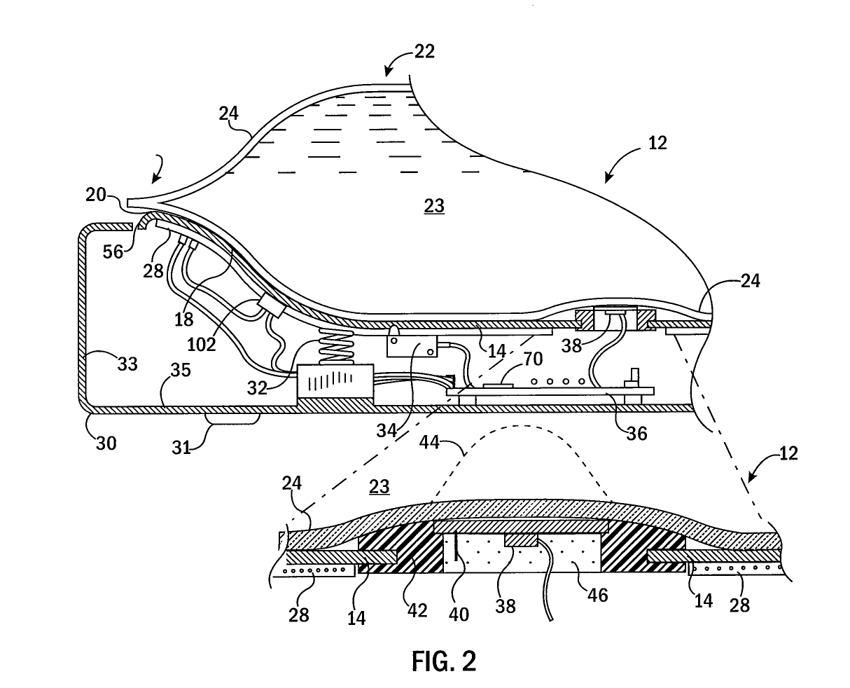

Referring now also to FIG. 2, basin 12 is sized to receive and substantially fully support a dialysis bag 22 holding, for example, five liters of infusion liquid 23. The infusion liquid 23 may, for example, be a saline solution for peritoneal dialysis.

As is understood in the art, the dialysis bag 22 may be constructed of a flexible transparent plastic material, such as a vinyl, and fabricated by joining two sheets 24 of the material at a peripheral seam 26 to provide within the seam 26 an enclosed pocket into which sterile infusion liquid 23 may be held.

The flexible material of the dialysis bag 22 permits the dialysis bag 22 to adopt a variety of different volumetric configurations and the shape of the basin 12 is designed to promote a particular configuration maximizing heat transfer to the contained infusion liquid 23. In particular, the basin 12 is shaped to support the dialysis bag 22 with one lower sheet 24 of the dialysis bag 22 lying in close abutment to the floor 14, sidewalls 16, and end walls 18 of the basin 12 and so that the seams 26 between the sheets 24 lie generally along a horizontal plane displaced to be approximately symmetrically located between the sheets 24 of the dialysis bag 22 to substantially eliminate buckling or wrinkling of the lower sheet 24 and minimizing a vertical thickness of the infusion liquid 23 within this constraint. In this way, contact between the dialysis bag 22 and the heater 28 may be substantially maximized and the thermal path to any volume element of the infusion liquid 23 from the basin 12 reduced.

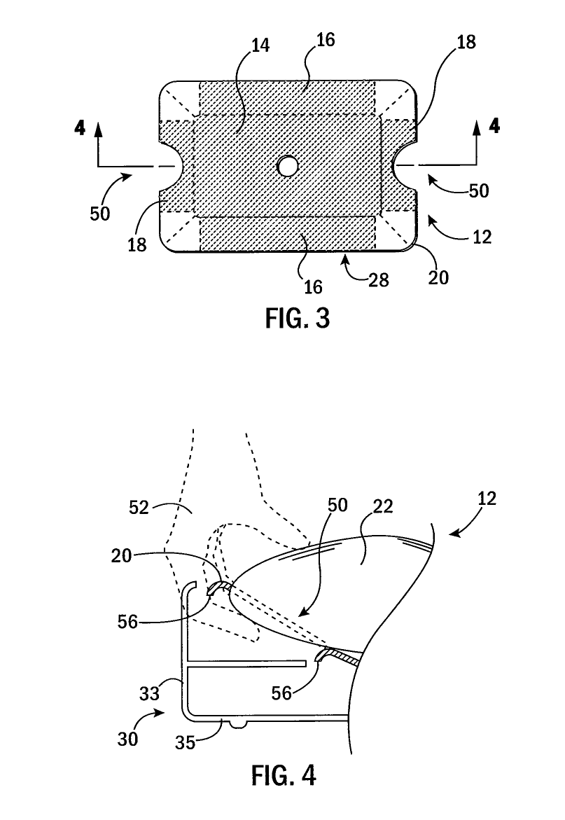

Referring momentarily to FIGS. 2 and 3, a heater 28 may be attached to an underside of the basin 12 to attach in the regions of the floor 14, the sidewalls 16, and the end walls 18 so that each may conduct heat directly into the supported dialysis bag 22. The heater 28 may be substantially continuous over the surfaces except for sections near the area of the corners of the basin 12 at the joining of end walls 18 and sidewalls 16 to facilitate manufacturing and except for small openings for basin supporting structure, thermal sensors and the like as will be described below. Generally heater 28 contacts the basin 12 over a large area so that a low temperature (gentle) heat implemented over the portions of the basin 12 contacting the dialysis bag 22 10 rapidly heat the contained infusion liquid 23 without large temperature differences. For this purpose, the area of the heater 28 will typically be greater than 50 square inches and preferably greater than 100 square inches or more.

A suitable heater 28 may be a silicone rubber electric heater. As is understood in the art, a silicone rubber electric heater provides a resistive conductive element, for example an etched foil or wire, embedded in a silicone rubber mat and is broadly commercially available from multiple vendors.

Referring now to FIG. 2, the basin 12 may be held within a housing 30 as supported on one or more spring elements 32, for example helical compression springs. The housing 30 maybe fabricated of an injection molded thermoplastic or the like and may include a lower surface having downwardly extending feet 31 for support on a table or the like. The housing 30 may have vertically extending sidewalls 33 above a horizontally extending base wall 35 and may be open at its upper surface to expose the upper surface of the basin 12 for receipt of the dialysis bag 22 within the basin 12. The weight of the dialysis bag 22 on the basin 12 compresses the basin downward against the spring elements 32 and into the housing 30 activating a switch 34 indicating a presence of a dialysis bag 22 that may require heating. The switch 34 may be a simple mechanical microswitch, an optical switch, a strain gauge, a magnetic switch or the like providing an electrical signal that may communicate with the controller board 36 held within the housing 30.

The controller board 36 may also communicate with the heater 28 so that the heater 28 may be activated only when a dialysis bag 22 is in place in the basin 12. This weight-based sensing system provides for robust and positive identification of the placement of a dialysis bag 22 in the basin 12 in contrast, for example, to optical bag sensors which may require more sophisticated processing to detect the dialysis bag 22 and overcome the transparent nature of the dialysis bag 22 and the contained infusion liquid 23.

Referring still to FIG. 2, controller board 36 may also communicate with a temperature sensor pair 38 positioned approximately in the center of the floor 14 to be near a center region of the liquid 23 contained in the dialysis bag 22. This location provides a good measure of the average temperature of the liquid 23 in the dialysis bag 22.

The temperature sensor pair 38 may be mounted on a heat collector plate 40 that projects upward from a plane of the floor 14 of the basin 12 to provide a mesa-form pushing upward slightly on the lower sheet 24 into the dialysis bag 22 to ensure good contact therewith without substantially decreasing the thermal contact between the dialysis bag 22 and the floor 14 of the basin 12. The heat collector plate 40 and temperature sensor pair 38 are thermally isolated from the heater 28 and the floor 14 by means of this offset and an aperture cut in the heater 28 and floor 14 and separated from the heat collector plate 40 by a thermally insulating spacer ring 42.

By promoting thermal contact between the temperature sensor pair 38 and the dialysis bag 22 through sheet 24 and distancing thermal proximity of the temperature sensor pair 38 and the heater 28, a localized sensing region 44 projecting into the infusion liquid 23 may be created allowing better assessment and control of the liquid temperature. T

A rear surface of the temperature sensor pair 38 may be embedded in a thermally insulating material 46 reducing the temperature drop between the liquid 23 and the sensor pair 38 promoting the ability to detect internal liquid temperature with an external temperature sensor pair 38 as will be discussed below.

Referring to FIGS. 1, 3, and 4, the end walls 18 of the basin 12 and corresponding regions of the housing 30 may include cutout 50 sized to receive hands 52 of a user when the hands 52 are positioned to grasp the dialysis bag 22 at its ends along its greater length as a user places the dialysis bag 22 down into the basin 12 or lifts it there from. The cutouts 50 expose a portion of an under surface of the dialysis bag 22 in the basin 12 simplifying its gripping by the hands 52 during removal or insertion.

Referring to FIGS. 1 and 4, the rim 20 of the basin 12 and regions around the cutout 50 may have drip edges 56 formed therein, the drip edges 56 being downwardly extending edges that prevent water overflowing out of the basin 12 from traveling downward along the lower surface of the basin 12, as adhered thereto by surface tension, into the region of the controller board 36.

Referring now to FIGS. 1 and 6, an outer front surface of the housing 30 may provide for a control panel 60 having an alphanumeric display 62, for example, displaying a current temperature of the infusion liquid 23 or desired setpoint of the infusion liquid 23, setting switches 64 allowing changing of the setpoint of temperature control of the liquid 23, a mode switch 66 changing a mode of display 62, and a ready indicator 68 indicating that the temperature of the liquid 23 is at its proper setpoint, as will be described. The switches 64 and 66 may, for example, be membrane switches of a type known in the art and the ready indicator a light emitting diode.

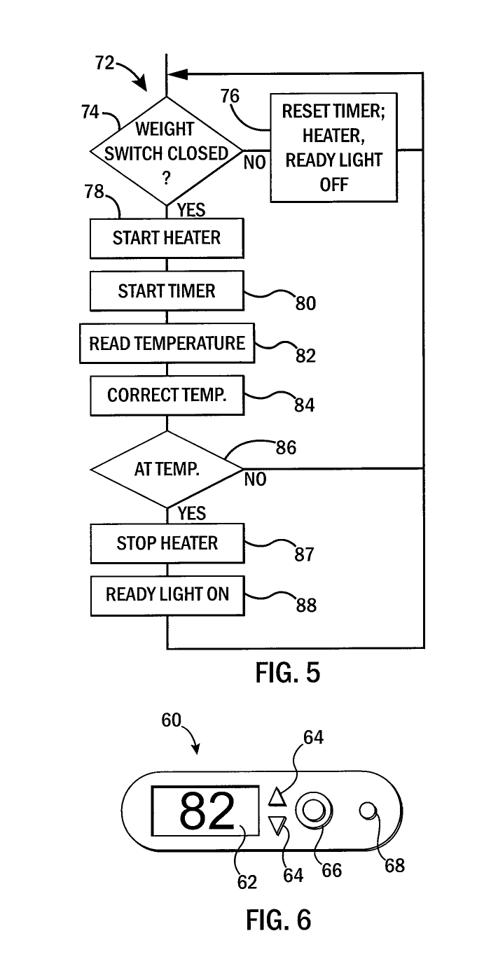

Referring now to FIGS. 2 and 5, the controller board 36 may include a microcontroller 70 or similar processor of a type well known in the art and including generally a processor, memory and various I/O circuits. The microcontroller 70 may receive signals from the thermal sensor pair 38 the switch 34 and the switches 64 and 66 and may provide control signals to the display 62 and the ready indicator 68 and the heater 28. An internal program 72 executed by the microcontroller 70, as indicated by decision block 74, may first detect whether a dialysis bag 22 is in place in the basin 12 (as shown in FIG. 2) using the signal from the switch 34. If not, an internal timer used for determining the age of the dialysis bag 22 (with respect to how long it has been heated) is reset, and the ready light 68 and the heater 28 are turned off (if they are on) as indicated by process block 76.

If a dialysis bag 22 is in place, the heater 28 may be turned on as indicated by process block 78, for example, by means of solid-state switches such as an SCR on the controller board 36 as controlled by the microcontroller 70. At this time a bag age timer is started as indicated by process block 80 that will keep track of how long the dialysis bag 22 has been in place and heated.

At process block 82, the temperature of the temperature sensor pair 38 is read and the separate temperature readings compared to see if they are beyond the predetermined range indicating an error at process block 84. If an error is indicated the heater may be turned off and in error indicated on the display 60, otherwise the temperature values are averaged and this temperature is corrected for an empirically determined temperature offset representing a difference between the temperature of the contained liquid 23 and the temperature at the sensor pair 38 caused by the thermal resistance therebetween. This temperature difference will generally be added to the temperature read at the temperature sensor pair 38 at process block 84.

At decision block 86, a determination is made to see whether the temperature of the contained liquid 23 within the dialysis bag 22 is at a desired setpoint, the latter which may be entered by the user through the control panel 60 by conventional data entry routines not shown. This comparison considers the temperature at the temperature sensor pair 38 as corrected by the temperature offset described above. The range of set points entered by the user may be limited to those representing a safe range for the infusion liquid 23.

If at decision block 86 the deduced temperature of the infusion liquid 23 is below a predetermined range with respect to the desired setpoint, the program 72 loops back to decision block 74, otherwise the program proceeds to process block 87 and the heater is turned off and the ready indicator 68 illuminated indicating that proper temperature has been obtained per process block 88.

At any time during this process, the mode switch 66 may be activated to allow the user to switch display 62 between the temperature of the contained liquid 23, the desired setpoint and the bag age. The temperature of the contained liquid 23 is corrected with the temperature offset as described above.

Referring to FIGS. 1 and 2, the controller board 36 may receive power from a line cord 100 passing into the housing 30 and having an associated line switch as is understood in the art. Multiple temperature switches 102 may be placed against the under surface of the basin 12 to monitor over temperature of the basin 12 independent of the operation of the controller board 36 to disconnect the heater 28 when over temperature conditions exist.

Ideally the upper surface of the basin 12 will be substantially bare to provide improved thermal conductivity; however, it will be understood that a thin protective layer of plastic materials and/or anodization may be provided on the surface without unduly decreasing the effectiveness of the device. By providing a broad area, low-temperature heating of a substantially flattened dialysis bag 22, rapid and accurate temperature control of the contained liquid 23 may be effected.

Certain terminology is used herein for purposes of reference only, and thus is not intended to be limiting. For example, terms such as “upper”, “lower”, “above”, “below”, “clockwise”, and “counterclockwise” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to a controller, computer or processor or its equivalent can be understood to include one or more computational devices including microprocessors, field programmable gate arrays, and application specific integrated circuits that can implement state aware logic and that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

We claim:

1. A warming system for infusible liquids comprising:
an upwardly open basin sized to receive a flexible polymer bag holding the infusible liquid, the basin providing a substantially horizontal floor having upwardly sloped opposed ends and sides adapted to support the flexible polymer bag in contact with the floor, end, and sides so as to reduce a vertical thickness of the bag while maintaining a substantially wrinkle free contact between the bag and the basin; and
a heater element attached to the basin to conduct heat through the basin and bag into the contained infusible liquid when the bag is held within the basin.

2. The warming system of claim 1 wherein the heater element contacts each of the floor, ends, and sides to heat each of these surfaces and to conduct heat through each of these surfaces into the infusible liquid.

3. The warming system of claim 2 wherein the basin includes a conductive metal heat spreader and the heater is attached to an outer surface of the basin.

4. The warming system of claim 3 wherein the basin is mounted within a housing open at a top to expose an upper surface of the basin.

5. The warming system of claim 4 further a dialysate sensor switch sensing presence of the dialysate to control the heater to be on only when dialysate is present in the basin in a predetermined amount.

6. The warming system of claim 5 wherein the basin is attached to the housing by spring elements allowing the basin to move under a predetermined weight of a contained bag and wherein the dialysate sensor is an electrical switch sensing this movement to control the heater.

7. The warming system of claim 6 further including a thermal sensor protruding upward from a floor of the basin to contact a bag placed within the basin.

8. The warming system of claim 7 wherein the thermal sensor is substantially centered within the basin.

9. The warming system of claim 8 wherein the thermal sensor includes a thermal isolation element separating the thermal sensor from the basin.

10. The warming system of claim 9 wherein the thermal isolation element is a thermally insulating ring supporting the thermal sensor in a hole through the basin.

11. The warming system of claim 9 wherein the thermal sensor comprises two sensor elements that may be independently read and the readings combined to determine a temperature.

12. The warming system of claim 11 wherein the floor, ends, and sides together provide an area of greater than 100 square inches.

13. The warming system of claim 7 further including user controls for providing a temperature display of a temperature of the infusible liquid and further including a correction circuit communicating with the display and the temperature sensor to add a temperature offset to a reading of the temperature sensor for display on the display, the temperature offset based on an empirically determined thermal resistance between the heater element and the infusible liquid.

14. The warming system of claim 7 further including a control system communicating between the heater and the thermal sensor for controlling the heater according to a reading of the thermal sensor and a desired temperature set point.

15. The warming system of claim 14 wherein the control system includes a correction circuit to determine a temperature offset based on an empirically determined thermal resistance between the heater element and the infusible liquid and wherein the control system controls the heater to match a temperature from the temperature sensor plus the temperature offset to the desired temperature setpoint.

16. The warming system of claim 1 wherein the basin includes cut out portions exposing an under surface of the bag when the bag is supported in the basin, the cut out portions positioned to receive a user's hands for grasping the bag for placement or removal of the bag into or from the basin.

17. The warming system of claim 1 wherein edges of the basin provide for a downwardly extending rim providing a drip edge preventing water overflowing from the basin from traveling along and under surface of the basin.

18. The warming system of claim 1 wherein the heater is a flexible silicone heater pad adhered to and under the surface of a metallic basin.
